(19) United States
(12) Patent Application Publication
(10) Pub. No.: US 2026/0257894 A1
(43) Pub. Date: Sep. 3, 2026

(54) CRANE

(71) Applicant: TADANO LTD., Kagawa (JP)

(72) Inventors: Takashi KAWANO, Kagawa (JP); Kimihiko TERATA, Kagawa (JP); Shota NAKAMATSU, Kagawa (JP); Naoki ISHIHARA, Kagawa (JP)

(73) Assignee: TADANO LTD., Kagawa (JP)

(21) Appl. No.: 18/872,835

(22) PCT Filed: Jun. 15, 2023
(86) PCT No.: PCT/JP2023/022315

§ 371 Date: Dec. 9, 2024

(30) Foreign Application Priority Data
Jun. 24, 2022 (JP) 2022-102117

(51) Int. Cl. B66C 13/12; B66C 23/38; B66C 23/42; B66C 23/84

(52) U.S. Cl. CPC B66C 13/12; B66C 23/38; B66C 23/84; B66C 23/42; B66C 2700/0371

(57) ABSTRACT

This crane includes: a travel body that has a travel motor; a turning body that is provided above the travel body and has an upper device; a transmission member that is provided between the travel body and the turning body; and a power source that is provided to the travel body and that supplies electric power to both the travel motor and the upper device. The transmission member includes: a swivel joint unit that constitutes a flow path for a fluid to be supplied from the travel body to the turning body; a weak-electric-system slip ring unit that constitutes a transmission path for a signal to be transmitted from the travel body to the turning body; and a strong-electric-system slip ring unit that constitutes a cable way for electric power to be supplied from the power source to the upper device.

### Technical Field

The present invention relates to a crane.

### BACKGROUND ART

Patent Literature 1 discloses a mobile crane including a lower travel body having a travel function and an upper swivel body provided swivelably to the upper portion of the lower travel body. The lower travel body includes an engine and travels on the basis of the power of the engine.

### CITATION LIST

### Patent Literature

Patent Literature 1: JP 2012-96928 A

### SUMMARY OF THE INVENTION

### Problems to be Solved by the Invention

Nowadays, from a viewpoint of environmental protection, such a crane as described above requires motorizing.

An object of the present invention is to provide a crane capable of traveling due to electric power.

### Solutions to Problems

According to an aspect of the present invention, a crane includes:
a travel body including a travel motor;
a swivel body provided above the travel body, the swivel body including an upper device;
a transmission member provided between the travel body and the swivel body; and
a power source provided to the travel body, the power source being configured to supply electric power to both the travel motor and the upper device, in which
the transmission member includes:
a swivel joint unit included in a flow path for a fluid to be supplied from the travel body to the swivel body;
a weak-electric-system (a low-voltage-system) slip ring unit included in a transmission path for a signal to be transmitted from the travel body to the swivel body; and
a strong-electric-system (a high-voltage-system) slip ring unit included in an electric path for electric power to be supplied from the power source to the upper device.

### Effects of the Invention

According to the present invention, provided can be a crane capable of traveling due to electric power.

### BRIEF DESCRIPTION OF DRAWINGS

FIG. 1 is a schematic view of a mobile crane according to an embodiment.

FIG. 2 is a block diagram schematically illustrating a systematic configuration of the mobile crane.

FIG. 3 is a perspective view of the crane partially omitted in configuration.

FIG. 4 is a schematic sectional view illustrating the periphery of a motor viewed from left.

FIG. 5 is a schematic sectional view of a transmission member.

FIG. 6 is a sectional view taken along line X-X of FIG. 5.

FIG. 7 is a schematic view illustrating the periphery of batteries viewed from above.

### DESCRIPTION OF EMBODIMENTS

A crane according to an exemplary embodiment of the present invention will be described in detail below on the basis of the drawings. Note that the crane according to the following embodiment is an exemplary crane according to the present invention, and thus the present invention is not limited to the following embodiment.

### Embodiment

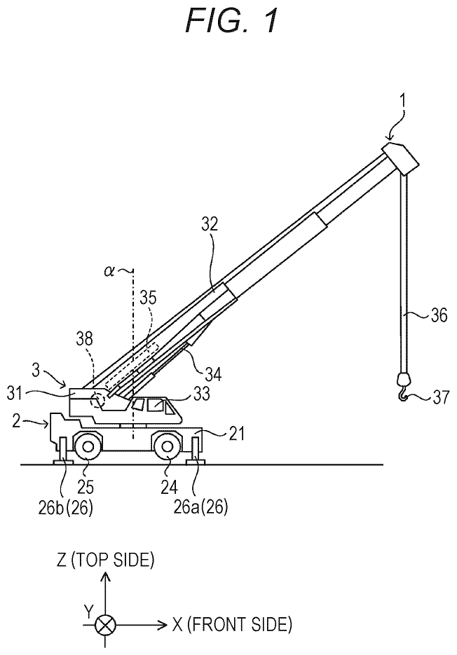

FIG. 1 is a schematic view of a mobile crane 1 according to the present embodiment (rough terrain crane in the drawing). Examples of such a mobile crane include an all-terrain crane, a truck crane, and a truck loader crane (also referred to as a cargo crane). Note that a crane according to the present invention may be any type of crane.

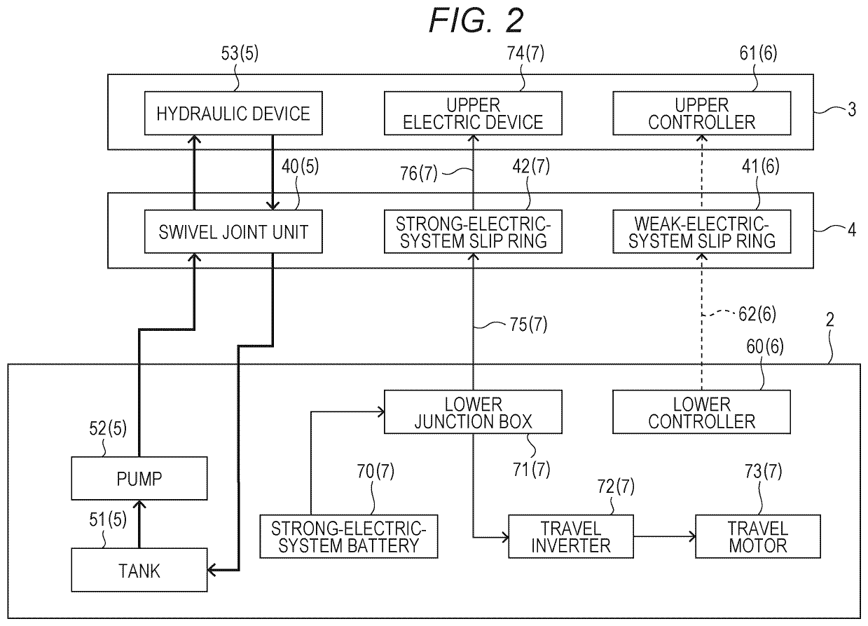

The mobile crane 1 includes a lower travel body 2 and an upper swivel body 3. The mobile crane 1 serves as an electric crane including a strong-electric-system battery 70 (refer to FIG. 2). The mobile crane 1 travels on the basis of electric power supplied from the strong-electric-system battery 70. That is, the mobile crane 1 includes no engine.

The mobile crane 1 performs an operation different from traveling (e.g., a crane operation, cooling, and/or heating) on the basis of electric power supplied from the strong-electric-system battery 70. The crane operation corresponds to, for example, swiveling and/or winching in load conveyance. A specific configuration of the mobile crane 1 will be described below.

The configuration of the upper swivel body 3 will be now described with reference to FIG. 1. FIG. 1 is a schematic view of the mobile crane 1.

The upper swivel body 3 is provided to the upper portion of the lower travel body 2 and is capable of swiveling around a swivel central axis a with respect to the lower travel body 2. The upper swivel body 3 includes a swivel 31, a telescopic boom 32, and a cab 33.

The swivel 31 is supported by the upper portion of the lower travel body 2 through a bearing (not illustrated). The swivel 31 swivels on the basis of power generated by a swiveling actuator (not illustrated) provided to the upper swivel body 3. In the present embodiment, the swiveling actuator serves as a hydraulic motor. The motor operates on the basis of supply/discharge of hydraulic oil. The hydraulic oil is supplied from the lower travel body 2. Note that the swiveling actuator may be an electric motor. In this case, the swiveling electric motor drives on the basis of electric power supplied from the strong-electric-system battery 70, described later.

The telescopic boom 32 is supported by the swivel 31 and includes a plurality of booms telescopically in combination. The telescopic boom 32 can vary in derricking angle (can perform a derricking motion) on the basis of power generated by a derricking cylinder 34.

The derricking cylinder 34 serves as a hydraulic telescopic cylinder and is provided to the upper swivel body 3. The derricking cylinder 34 operates on the basis of supply/discharge of hydraulic oil. Note that the hydraulic oil is supplied from the lower travel body 2.

The telescopic boom 32 telescopes on the basis of power generated by a telescoping cylinder 35. The telescoping cylinder 35 serves as a hydraulic cylinder and is provided inside the telescopic boom 32. The telescoping cylinder 35 operates on the basis of supply/discharge of hydraulic oil. Note that the hydraulic oil is supplied from the lower travel body 2.

The telescopic boom 32 supports a wire rope 36. The wire rope 36 hangs down from the leading end of the telescopic boom 32 and has a leading end provided with a hook 37. Part of the wire rope 36 is wound around a winch 38.

The winch 38 drives (rotates) on the basis of power generated by a winch actuator (not illustrated). In the present embodiment, the winch actuator is provided to the swivel 31 and serves as a hydraulic motor. The motor operates on the basis of supply/discharge of hydraulic oil. The hydraulic oil is supplied from the lower travel body 2.

In response to rotation of the winch 38, the wire rope 36 is wound up or off in accordance with the direction of rotation of the winch 38. Note that the winch motor may be an electric motor. In this case, the winch electric motor drives on the basis of electric power supplied from the strong-electric-system battery 70, described later.

Next, the lower travel body 2 will be described with reference to FIGS. 1 to 7. Note that a Cartesian coordinate system (X, Y, Z) illustrated in each drawing is used for description of the structure of the lower travel body 2. An X direction is identical to the fore-aft direction of the lower travel body 2. The positive side of the X direction is identical to the front side of the lower travel body 2. The negative side of the X direction is identical to the rear side of the lower travel body 2. A Y direction is identical to the left-right direction of the lower travel body 2. The positive side of the Y direction is identical to the left side in forward viewing from the lower travel body 2. The negative side of the Y direction is identical to the right side in forward viewing from the lower travel body 2. A Z direction is identical to the up-down direction of the lower travel body 2. The positive side of the Z direction is identical to the top side of the lower travel body 2. The negative side of the Z direction is identical to the bottom side of the lower travel body 2.

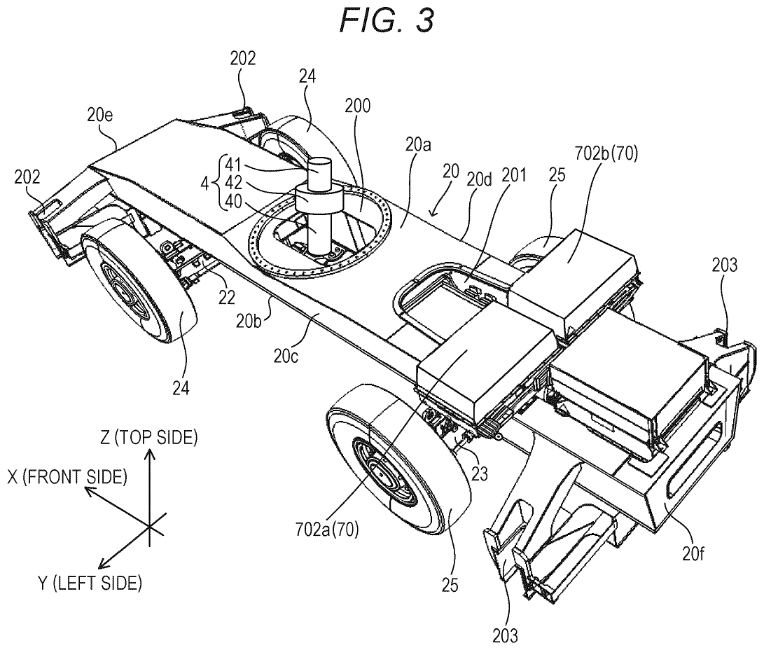

The lower travel body 2 is capable of traveling due to electric power. Specifically, as illustrated in FIGS. 1 and 3, the lower travel body 2 includes a frame 20, a body 21, a front axle 22, a rear axle 23, front tires 24, rear tires 25, and an outrigger 26.

The frame 20 is, for example, a boxy member that extends in the fore-aft direction and has a section rectangular in shape, constituting the framework of the lower travel body 2. The frame 20 includes an upper plate 20a, a lower plate 20b, a left plate 20c, a right plate 20d, a front plate 20e, and a rear plate 20f.

The frame 20 has a slip-ring arrangement space 200 due to a through hole penetrating through the frame 20 in the up-down direction. The slip-ring arrangement space 200 in the frame 20 is located at the center between the front axle 22 and the rear axle 23.

The frame 20 has a battery housing space 201 due to a through hole penetrating through the frame 20 in the up-down direction. The battery housing space 201 is located ranging from a portion above the rear axle 23 to the rear end of the frame 20. That is, the battery housing space 201 may be regarded as being provided to the rear of the frame 20. In the frame 20, the portion in which the battery housing space 201 is formed has a cross section corresponding, in shape, to a closed section made of a plurality of plates in continuity. Note that the cross section of the frame 20 means a section taken along a YZ plane from the frame 20.

The battery housing space is not limited to the illustrative position. The battery housing space may be located ranging from a portion above the front axle 22 to the front end of the frame 20. In this case, the battery housing space may be achieved with a through hole penetrating through the frame 20 in the up-down direction.

The frame 20 includes a pair of front outrigger supports 202 at its front end. The frame 20 includes a pair of rear outrigger supports 203 at its rear end.

The body 21 (refer to FIG. 1) serves as a member constituting the outer form of the lower travel body 2 and is supported by the frame 20.

The front axle 22 corresponds to a shaft member extending in the left-right direction and is supported by a portion closer to the front end of the lower plate 20b in the frame 20. The front tires 24 are supported rotatably one-to-one at both ends in the left-right direction of the front axle 22.

The rear axle 23 corresponds to a shaft member extending in the left-right direction and is supported by a portion closer to the rear end of the lower plate 20b in the frame 20. The rear tires 25 are supported rotatably one-to-one at both ends in the left-right direction of the rear axle 23. Note that, in the present embodiment, the mobile crane 1 corresponds to a so-called twin-axle mobile crane because of the front axle 22 and the rear axle 23.

Note that a so-called multi-axle mobile crane including three or more axles may be provided as a mobile crane.

The outrigger 26 includes a pair of front outriggers 26a and a pair of rear outriggers 26b. The pair of front outriggers 26a are supported one-to-one by the pair of front outrigger supports 202 in the frame 20. The pair of rear outriggers 26b are supported one-to-one by the pair of rear outrigger supports 203 in the frame 20.

The mobile crane 1 includes a transmission member 4 provided between the lower travel body 2 and the upper swivel body 3. Specifically, the transmission member 4 is disposed in the slip-ring arrangement space 200 of the frame 20. The transmission member 4 serves as a member for transmitting electric power, a fluid (hydraulic oil and/or air), and a signal between the lower travel body 2 and the upper swivel body 3 that rotate relatively.

The transmission member 4 includes a swivel joint unit 40, a weak-electric-system slip ring unit 41, and a strong-electric-system slip ring unit 42.

In addition, as illustrated in FIG. 2, the mobile crane 1 includes a hydraulic system 5, a weak electric system 6, and a strong electric system 7. The configuration of the transmission member 4 will be described below together with the hydraulic system 5, the weak electric system 6, and the strong electric system 7.

The hydraulic system 5 includes a tank 51, a pump 52, the swivel joint unit 40, and a hydraulic device 53. The constituent elements in the hydraulic system 5 are connected through a circuit indicated with bold lines in FIG. 2.

The tank 51 and the pump 52 are provided to the lower travel body 2. The pump 52 serves as an electric pump that operates on the basis of electric power supplied from the strong-electric-system battery 70, described later. The pump 52 supplies the hydraulic oil stored in the tank 51 to the swivel joint unit 40 through an oil path. Note that, referring to FIG. 2, a circuit through which the pump 52 and the strong-electric-system battery 70 are connected is omitted.

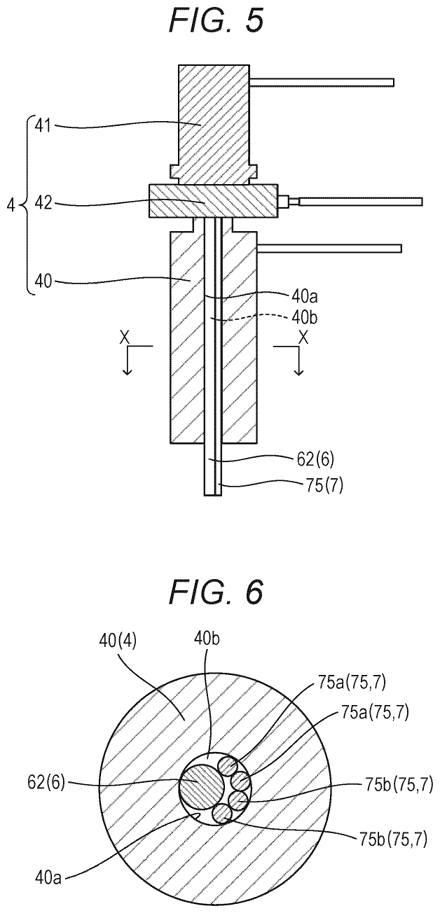

As illustrated in FIG. 5, the swivel joint unit 40 is provided lower than the strong-electric-system slip ring unit 42 in the transmission member 4. The swivel joint unit 40 is coupled to the strong-electric-system slip ring unit 42 through a fastening component (not illustrated), such as a bolt. In other words, the swivel joint unit 40 and the strong-electric-system slip ring unit 42 are releasably coupled through the fastening component.

The lower half of the swivel joint unit 40 is disposed in the slip-ring arrangement space 200. The upper half of the swivel joint unit 40 is disposed higher than the slip-ring arrangement space 200. That is, the upper end of the swivel joint unit 40 is disposed higher than the upper face of the frame 20 (upper plate 20a).

The swivel joint unit 40 includes a flow path for a fluid to be supplied from the lower travel body 2 to the upper swivel body 3 (e.g., hydraulic oil and/or compressed air) between the lower travel body 2 and the upper swivel body 3 that rotate relatively. Specifically, the swivel joint unit 40 transmits, to the hydraulic device 53 provided to the upper swivel body 3, the hydraulic oil supplied from the pump 52.

In the present embodiment, the hydraulic device 53 includes the swiveling actuator (not illustrated), the derricking cylinder 34, the telescoping cylinder 35, and the winch actuator (not illustrated). Note that the hydraulic oil used in the hydraulic device 53 returns to the tank 51 through the swivel joint unit 40.

The swivel joint unit 40 is shaped like a cylinder extending in the up-down direction and has a through hole 40a penetrating through the swivel joint unit 40 in the up-down direction. The swivel joint unit 40 includes a housing 40b due to the space surrounded by the inner circumferential face of the through hole 40a.

A lower weak-electric-system transmission path 62 included in the weak electric system 6 and a lower strong-electric-system electric path 75 included in the strong electric system 7 are disposed in the housing 40b. The lower weak-electric-system transmission path 62 and the lower strong-electric-system electric path 75 will be described later.

Note that the swivel joint unit 40 may transmit, for example, compressed air from the lower travel body 2 to the upper swivel body 3, in addition to the hydraulic oil. For example, the compressed air is transmitted, through the swivel joint unit 40, to a device, such as a brake, provided to the upper swivel body 3.

Next, the weak electric system 6 will be described. The weak electric system 6 includes a lower controller 60, the weak-electric-system slip ring unit 41, and an upper controller 61. The constituent elements in the weak electric system 6 are connected through a circuit indicated with dotted lines in FIG. 2.

The lower controller 60 transmits, for example, a video signal, a sensor-detected signal, or a control signal to the weak-electric-system slip ring unit 41 through the lower weak-electric-system transmission path 62. The control signal serves as a signal for controlling the operation of a device provided to the upper swivel body 3 as a control target (e.g., the hydraulic device 53 or an upper electric device 74). Hereinafter, the signals to be transmitted from the lower controller 60 to the weak-electric-system slip ring unit 41, which includes the above signals, are collectively referred to as a lower generated signal.

Note that the lower controller 60 may be a controller that operates a device provided to the lower travel body 2. Referring to FIG. 2, a circuit through which the lower controller 60 and a device different from the weak-electric-system slip ring unit 41 are connected is omitted.

The lower weak-electric-system transmission path 62 is an exemplary weak-electric-system transmission path and includes a so-called harness including a bundle of fine cables. Note that, referring to FIG. 6, for convenience, the lower weak-electric-system transmission path 62 is indicated as a single thick cable. The thick cable illustrated in FIG. 6 includes a bundle of fine cables.

As illustrated in FIGS. 5 and 6, the lower weak-electric-system transmission path 62 is disposed in the housing 40b of the swivel joint unit 40. The lower weak-electric-system transmission path 62 passes inside the housing 40b and the strong-electric-system slip ring unit 42 and is connected to the weak-electric-system slip ring unit 41.

The weak-electric-system slip ring unit 41 includes a transmission path for a signal to be transmitted from the lower travel body 2 to the upper swivel body 3 between the lower travel body 2 and the upper swivel body 3 that rotate relatively. As illustrated in FIG. 5, the weak-electric-system slip ring unit 41 is provided higher than the strong-electric-system slip ring unit 42 in the transmission member 4. The weak-electric-system slip ring unit 41 is coupled to the strong-electric-system slip ring unit 42 through a fastening component (not illustrated), such as a bolt. In other words, the weak-electric-system slip ring unit 41 and the strong-electric-system slip ring unit 42 are releasably coupled through the fastening component.

The weak-electric-system slip ring unit 41 corresponds to a so-called slip ring and transmits, to the upper controller 61, the lower generated signal transmitted from the lower controller 60 through the lower weak-electric-system transmission path 62.

The upper controller 61 transmits, to a control device that controls the operation of a device provided to the upper swivel body 3, the lower generated signal received from the weak-electric-system slip ring unit 41. Examples of the control device include a solenoid valve that controls the operation of the hydraulic device 53 and a controller that controls the operation of the upper electric device 74.

Note that, in addition to the lower generated signal, the weak electric system 6 may transmit, from the lower travel body 2 to the upper swivel body 3, for example, information regarding the operation of a device provided to the upper swivel body 3 and/or a current at a predetermined voltage or less to be supplied to the device.

Next, the strong electric system 7 will be described. The strong electric system 7 serves as a system that allows the lower travel body 2 to travel or an operation different from traveling (e.g., a crane operation and/or heating) to be performed on the basis of electric power supplied from the strong-electric-system battery 70. The configuration of the strong electric system 7 will be described below.

As illustrated in FIG. 2, the strong electric system 7 includes, as main elements, the strong-electric-system battery 70, a lower junction box 71, a travel inverter 72, a travel motor 73, the strong-electric-system slip ring unit 42, and the upper electric device 74. The constituent elements in the strong electric system 7 are connected through a circuit indicated with fine solid lines in FIG. 2.

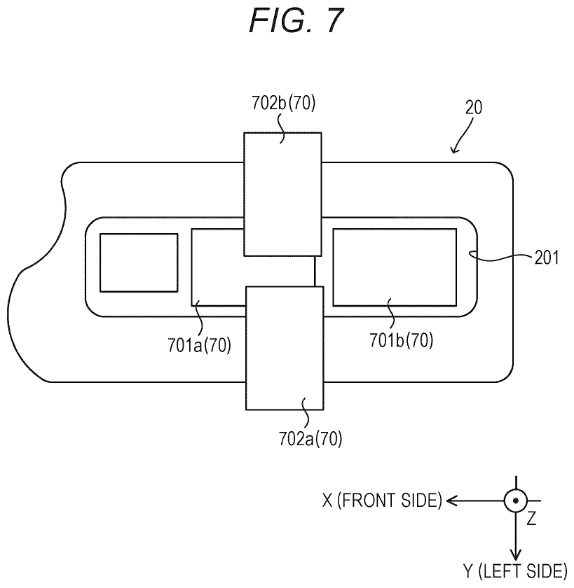

The strong-electric-system battery 70 is an exemplary power unit and includes, as illustrated in FIG. 7, a plurality of batteries 701a, 701b, 702a, and 702b.

The batteries 701a and 701b are disposed in the battery housing space 201 of the frame 20. In the present embodiment, the dead space of the frame 20 can be effectively used as above. Thus, the strong-electric-system battery 70 can be disposed in a compact manner. In addition, the strong-electric-system battery 70 can be inhibited from being damaged on impact. The batteries 702a and 702b are disposed outside the frame 20 and above the batteries 701a and 701b.

The lower junction box 71 is provided to the lower travel body 2 and performs allocation of electric power supplied from the strong-electric-system battery 70. The lower junction box 71 is connected to the strong-electric-system battery 70 and the travel inverter 72.

The travel inverter 72 is provided to the lower travel body 2 and is connected to the travel motor 73. The travel inverter 72 adjusts the current received from the lower junction box 71 and then transmits the adjusted current to the travel motor 73.

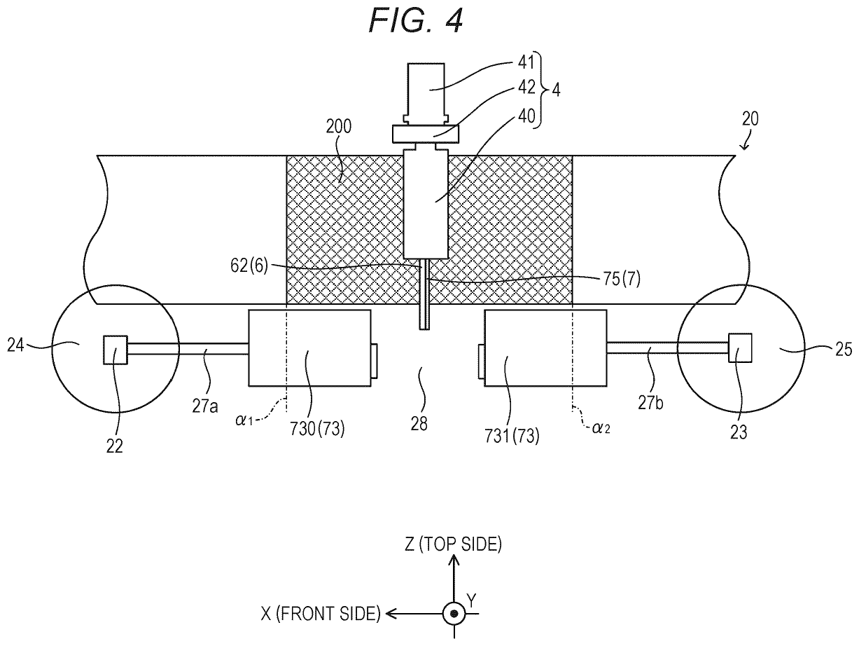

As illustrated in FIG. 4, the travel motor 73 includes a front travel motor 730 and a rear travel motor 731. The front travel motor 730 and the rear travel motor 731 are provided below the frame 20. In addition, the front travel motor 730 and the rear travel motor 731 are provided between the front axle 22 and the rear axle 23.

The front travel motor 730 has an output shaft connected to a front driving shaft 27a. The front driving shaft 27a has a front end connected to the front axle 22 through a gear (e.g., a speed reducer).

The rear travel motor 731 has an output shaft connected to a rear driving shaft 27b. The rear driving shaft 27b has a rear end connected to the rear axle 23 through a gear (e. g., a speed reducer).

In the present embodiment, depending on the lengths of the front driving shaft 27a and the rear driving shaft 27b, the positions in the fore-aft direction of the front travel motor 730 and the rear travel motor 731 can be adjusted. Thus, the weight balance of the entire mobile crane 1 can be adjusted depending on the specifications of the mobile crane 1.

A space 28 is provided between the front travel motor 730 and the rear travel motor 731 in the fore-aft direction. The space 28 is regarded as a region provided below the transmission member 4. That is, the front travel motor 730 and the rear travel motor 731 are opposed in the fore-aft direction across the region below the transmission member 4.

The cables included in the lower weak-electric-system transmission path 62 and the lower strong-electric-system electric path 75 in connection with the transmission member 4 are disposed in the space 28. Such consolidation of the cables in the space 28 achieves space saving. Note that, in the present embodiment, power cables for supplying electric power to the front travel motor 730 and the rear travel motor 731 are routed out of the space 28.

At the time of maintenance of the front travel motor 730, the rear travel motor 731, and the transmission member 4, a maintainer can gain access to the front travel motor 730, the rear travel motor 731, and the transmission member 4 (particularly, the swivel joint unit 40) from below the space 28. Then, the maintainer performs maintenance in the space 28. In this case, since the respective power cables for the front travel motor 730 and the rear travel motor 731 are routed out of the space 28, an improvement can be made in the efficiency of maintenance.

As illustrated in FIG. 4, the front travel motor 730 and the rear travel motor 731 are disposed such that at least part of each of the front travel motor 730 and the rear travel motor 731 overlaps a downward extended region (region between a dot-and-dash line ai and a dot-and-dash line α₂ in FIG. 4) of the slip-ring arrangement space 200 (region indicated in a diagonal lattice pattern in FIG. 4).

The front travel motor 730 and the rear travel motor 731 described above drive, under control of a control unit (not illustrated), on the basis of electric power supplied from the strong-electric-system battery 70.

In addition, as illustrated in FIG. 2, the lower junction box 71 is connected to the strong-electric-system slip ring unit 42 of the transmission member 4 through the lower strong-electric-system electric path 75. The lower junction box 71 transmits, to the strong-electric-system slip ring unit 42 through the lower strong-electric-system electric path 75, the electric power supplied from the strong-electric-system battery 70. Note that the voltage based on the electric power supplied from the strong-electric-system battery 70 has a value or more enabling the upper electric device 74 to operate.

As illustrated in FIGS. 5 and 6, the lower strong-electric-system electric path 75 is disposed in the housing 40b of the swivel joint unit 40. The lower strong-electric-system electric path 75 passes through the housing 40b and is connected to the strong-electric-system slip ring unit 42. The lower strong-electric-system electric path 75 includes a plurality of cables.

In the present embodiment, in the housing 40b, the lower strong-electric-system electric path 75 and the lower weak-electric-system transmission path 62 are disposed adjacently in parallel. In such a configuration, a signal passing through the lower weak-electric-system transmission path 62 is likely to be affected by noise based on a current flowing through the lower strong-electric-system electric path 75. Thus, preferably, a shield member (not illustrated) is provided between the lower strong-electric-system electric path 75 and the lower weak-electric-system transmission path 62.

Note that the lower strong-electric-system electric path 75 includes a plurality of electric-path sets (routes). Each electric-path set includes a single cable 75a connected to the positive terminal of the strong-electric-system battery 70 and a single cable 75b connected to the negative terminal of the strong-electric-system battery 70. Note that, referring to FIG. 6, two electric-path sets are illustrated.

Due to adoption of such a configuration, the lower strong-electric-system electric path 75 can be efficiently routed in the housing 40b of the swivel joint unit 40, leading to effective use of the space. As a result, the transmission member 4 is small in size with the swivel joint unit 40 having a small inner diameter (namely, with the housing 40b having a small diameter).

From a viewpoint of fail-safe, as a preferable configuration, the lower strong-electric-system electric path 75 includes a plurality of electric-path sets (routes). That is, even in a case where one electric-path set (one route) breaks down, electric power can be supplied to the upper swivel body 3 through another electric-path set (route). In such a configuration, preferably, the electric power supplied to the upper swivel body 3 through one electric-path set (one route) enables at least the upper electric device 74 of the upper swivel body 3 to perform an evacuation operation. The evacuation operation is, for example, an operation of lowering a hoisted load onto the ground.

The lower strong-electric-system electric path 75 may include a plurality of electric-path sets (routes) in separation that ranges from the upstream side of the swivel joint unit 40 (e.g., the lower junction box 71) to the strong-electric-system slip ring unit 42 or a predetermined position in the upper swivel body 3 and is integrated into a single electric path (single route) by the strong-electric-system slip ring unit 42 or at the predetermined position in the upper swivel body 3. Adoption of such a configuration causes an increase in the number of cables disposed in the housing 40b of the swivel joint unit 40, but each cable can be made fine, leading to effective use of the space of the housing 40b. The lower strong-electric-system electric path 75 is not limited to any cable and thus may include a so-called busbar. For example, such a busbar is preferably shaped like an arc along the inner face of the housing 40b of the swivel joint unit 40.

The strong-electric-system slip ring unit 42 includes an electric path for electric power to be supplied from the strong-electric-system battery 70 to the upper electric device 74 between the lower travel body 2 and the upper swivel body 3 that rotate relatively. In other words, the strong-electric-system slip ring unit 42 supplies, to the upper swivel body 3 through an upper strong-electric-system electric path 76, the electric power supplied from the lower travel body 2 through the lower strong-electric-system electric path 75.

The strong-electric-system slip ring unit 42 is an exemplary discoid feeder and is provided between the swivel joint unit 40 and the weak-electric-system slip ring unit 41 in the transmission member 4. In other words, the strong-electric-system slip ring unit 42 is disposed higher than the swivel joint unit 40 and higher than the lower travel body 2. As illustrated in FIG. 5, the outer diameter of the strong-electric-system slip ring unit 42 is larger than the respective outer diameters of the weak-electric-system slip ring unit 41 and the swivel joint unit 40. Since the strong-electric-system slip ring unit 42 is disposed higher than the lower travel body 2, a space for routing a cable to the outer circumference of the strong-electric-system slip ring unit 42 is easy to secure. In the present embodiment, since the strong-electric-system slip ring unit 42 is discoid in shape, a reduction can be made in the dimension in the up-down direction of the transmission member 4. As a result, the position of the upper face of the upper swivel body 3 disposed above the transmission member 4 can be set lower, leading to a reduction in the vehicle height of the mobile crane 1. Therefore, an improvement can be made in the mobility of the mobile crane 1 on roads or at work sites. Note that the position of the strong-electric-system slip ring unit 42 is not limited to that in the present embodiment. For example, the strong-electric-system slip ring unit 42 may be disposed lower than the upper face of the lower travel body 2.

The strong-electric-system slip ring unit 42 is coupled to the swivel joint unit 40 and the weak-electric-system slip ring unit 41 through fastening components (not illustrated), such as bolts. In other words, the strong-electric-system slip ring unit 42 is releasably coupled to the swivel joint unit 40 and the weak-electric-system slip ring unit 41 through fastening components.

As described above, in the present embodiment, the swivel joint unit 40, the weak-electric-system slip ring unit 41, and the strong-electric-system slip ring unit 42, which are independent devices, are releasably coupled together. Such a configuration contributes to noise reduction and an improvement in the easiness of maintenance.

In particular, since the swivel joint unit 40, the weak-electric-system slip ring unit 41, and the strong-electric-system slip ring unit 42 are provided as independent devices, depending of the specifications of the mobile crane, the order of arrangement of the swivel joint unit 40, the weak-electric-system slip ring unit 41, and the strong-electric-system slip ring unit 42 can be flexibly changed.

As in the present embodiment, in a case where the weak-electric-system slip ring unit 41 is provided uppermost in the transmission member 4 as a configuration, a worker who maintains the weak-electric-system slip ring unit 41 can maintain the weak-electric-system slip ring unit 41 without contact with the strong-electric-system slip ring unit 42 through which a current at a high voltage flows. As a result, an improvement can be made in the safety of maintenance.

In a case where the weak-electric-system slip ring unit 41 is disposed on the uppermost side in the transmission member 4 and the strong-electric-system slip ring unit 42 is disposed on the lowermost side in the transmission member 4 as a configuration, a reduction is made in the distance by which the lower weak-electric-system transmission path 62 and the lower strong-electric-system electric path 75 are adjacently disposed in the housing 40b. As a result, a reduction can be made in the influence of noise between the lower strong-electric-system electric path 75 and the lower weak-electric-system transmission path 62.

The strong-electric-system slip ring unit 42 corresponds to a so-called slip ring and transmits, to the upper electric device 74, the electric power transmitted from the strong-electric-system battery 70 through the lower strong-electric-system electric path 75.

The upper electric device 74 is an exemplary upper device and serves as a device that is provided to the upper swivel body 3 and operates on the basis of electric power from the strong-electric-system battery 70. The upper electric device 74 is, for example, a compressor for heating provided to the upper swivel body 3. Note that, in a case where the swiveling actuator is an electric motor, the swiveling electric motor is an exemplary upper device. In a case where the winch actuator is an electric motor, the winch electric motor is an exemplary upper device. In this case, the strong-electric-system slip ring unit 42 is connected to the swiveling electric motor and the wind electric motor through an upper junction box (not illustrated). Such an upper junction box functions to allocate, to the swiveling electric motor and the winch electric motor, the electric power supplied from the strong-electric-system battery 70 through the strong-electric-system slip ring unit 42.

In response to supply of electric power from the strong-electric-system battery 70, the swiveling electric motor drives on the basis of the electric power. Then, the swiveling electric motor causes the upper swivel body 3 to swivel.

In response to supply of electric power from the strong-electric-system battery 70, the winch electric motor drive on the basis of the electric power. Then, the winch electric motor causes the winch (not illustrated) to rotate. As a result, the wire rope 36 is wound up or off, so that the hook 37 moves upward or downward.

### <Notes>

In a mobile crane including an engine as a conventional structure, for heating in an upper swivel body 3, heated water is generated with heat from the engine in a lower travel body 2. Then, the heated water generated in the lower travel body 2 is fed to the upper swivel body 3 through a hose routed in the housing of a swivel joint unit. On the other hand, the mobile crane 1 according to the present embodiment includes no engine. Thus, no heated water for heating in the upper swivel body 3 is generated in the lower travel body 2. Therefore, the swivel joint unit 40 in the transmission member 4 described above has no function of feeding heated water from the lower travel body 2 to the upper swivel body 3. Therefore, no hose through which heated water flows is required to be routed in the housing 40b of the swivel joint unit 40. In the present embodiment, instead of such a hose, the already-described lower strong-electric-system electric path 75 is disposed in the housing 40b of the swivel joint unit 40.

### <Functions and Effects of Present Embodiment>

According to the present embodiment having such a configuration as above, the mobile crane 1 capable of traveling on the basis of electric power from the strong-electric-system battery 70 can be achieved. In particular, in the present embodiment, the transmission member 4 having such a configuration as described above is provided between the lower travel body 2 and the upper swivel body 3 that rotate relatively, so that electric power can be efficiently supplied from the strong-electric-system battery 70 to the upper electric device 74 provided to the upper swivel body 3. The other functions and effects of the mobile crane 1 according to the present embodiment have been described above.

This application is based upon and claims the benefit of priority from Japanese Patent Application No. 2022-102117, filed on Jun. 24, 2022, the entire contents of which are incorporated herein by reference.

### INDUSTRIAL APPLICABILITY

A crane according to the present invention is not limited to a rough terrain crane and thus may be any type of mobile crane, such as an all-terrain crane, a truck crane, or a truck loader crane (also, referred to as a cargo crane).

### REFERENCE SIGNS LIST

1 Mobile crane
2 Lower travel body
20 Frame
20a Upper plate
20b Lower plate
20c Left plate
20d Right plate
20e Front plate
20f Rear plate
200 Slip-ring arrangement space
201 Battery housing space
202 Front outrigger support
203 Rear outrigger support
21 Body
22 Front axle
23 Rear axle
24 Front tire
25 Rear tire
26 Outrigger
26a Front outrigger
26b Rear outrigger
27a Front driving shaft
27b Rear driving shaft
28 Space
3 Upper swivel body
31 Swivel
32 Telescopic boom
33 Cab
34 Derricking cylinder
35 Telescoping cylinder
36 Wire rope
37 Hook
38 Winch
4 Transmission member
40 Swivel joint unit
40a Through hole
40b Housing
41 Weak-electric-system slip ring unit
42 Strong-electric-system slip ring unit
5 Hydraulic system
51 Tank
52 Pump
53 Hydraulic device
6 Weak electric system
60 Lower controller
61 Upper controller
62 Lower weak-electric-system transmission path
7 Strong electric system
70 Strong-electric-system battery
701a, 701b First battery
702a, 702b Second battery
71 Lower junction box
72 Travel inverter
73 Travel motor
730 Front travel motor
731 Rear travel motor
74 Upper electric device
75 Lower strong-electric-system electric path
75a, 75b Cable
76 Upper strong-electric-system electric path

1. A crane comprising:
a travel body including a travel motor;
a swivel body provided above the travel body, the swivel body including an upper device;
a transmission member provided between the travel body and the swivel body; and
a power source provided to the travel body, the power source being configured to supply electric power to both the travel motor and the upper device, wherein the transmission member includes:
a swivel joint unit included in a flow path for a fluid to be supplied from the travel body to the swivel body;
a weak-electric-system slip ring unit included in a transmission path for a signal to be transmitted from the travel body to the swivel body; and
a strong-electric-system slip ring unit included in an electric path for electric power to be supplied from the power source to the upper device.

2. The crane according to claim 1, wherein the strong-electric-system slip ring unit includes a discoid feeder.

3. The crane according to claim 1, wherein the strong-electric-system slip ring unit is disposed higher than the travel body.

4. The crane according to claim 1, wherein the strong-electric-system slip ring unit is disposed higher than the swivel joint unit.

5. The crane according to claim 4, wherein the strong-electric-system slip ring unit is disposed between the swivel joint unit and the weak-electric-system slip ring unit.

6. The crane according to claim 4, wherein the swivel joint unit includes a space through which a weak-electric-system transmission path and a strong-electric-system electric path are inserted.

7. The crane according to claim 6, wherein the strong-electric-system electric path includes a plurality of routes routed in separation.

8. The crane according to claim 7, wherein the plurality of routes in separation of the strong-electric-system electric path ranges from an upstream side of the swivel joint unit to the strong-electric-system slip ring unit and is integrated into a single route by the strong-electric-system slip ring unit.

9. The crane according to claim 6, wherein the strong-electric-system electric path includes a busbar.

10. The crane according to claim 1, wherein the swivel joint unit, the weak-electric-system slip ring unit, and the strong-electric-system slip ring unit are releasably coupled together.
